(19) United States
(12) Patent Application Publication
(10) Pub. No.: US 2012/0299461 A1
(43) Pub. Date: Nov. 29, 2012

(54) PLASMA DISPLAY PANEL AND GREEN PHOSPHOR LAYER

(75) Inventor: Kojiro OKUYAMA, Nara (JP)

(73) Assignee: PANASONIC CORPORATION, Osaka (JP)

(21) Appl. No.: 13/569,681

(22) Filed: Aug. 8, 2012

Related U.S. Application Data
(63) Continuation of application No. PCT/JP2011/002782, filed on May 18, 2011.

(30) Foreign Application Priority Data
May 18, 2010 (JP) 2010-114716

(51) Int. Cl. C09K 11/80; H01J 61/44

(52) U.S. Cl. 313/484; 252/301.6 F

(57) ABSTRACT

The present disclosure is a plasma display panel including a green phosphor layer. In this plasma display panel, the green phosphor layer includes a phosphor represented by a general formula: aYO_{3/2}.(3−a)CeO_{3/2}.bAlO_{3/2}.cGaO_{3/2}, where 2.80≦a≦2.99, 1.00≦b≦5.00, 0≦c≦4.00, and 4.00≦b+c≦5.00 are satisfied. In this phosphor, a peak whose peak top is located in a range of diffraction angle 2θ of not less than 16.7 degrees but not more than 16.9 degrees is present in an X-ray diffraction pattern obtained by measurement on the phosphor using an X-ray with a wavelength of 0.774 Å. The green phosphor layer also includes a phosphor represented by a general formula: dZnO.(2−d)MnO.eSiO₂, where 1.80≦d≦1.90 and 1.00≦e≦1.02 are satisfied, in an amount of 30 wt % or more and 80 wt % or less of the total weight of green phosphors.

This is a continuation of International Application No. PCT/JP2011/002782, with an international filing date of May 18, 2011, which claims the foreign priority of Japanese Patent Application No. 2010-114716, filed on May 18, 2010, the entire contents of both of which are hereby incorporated by reference.

### BACKGROUND OF THE INVENTION

1. Field of the Invention

The present disclosure relates to a plasma display panel (PDP) and a green phosphor layer.

2. Description of Related Art

In recent years, various aluminate phosphors have been put to practical use as phosphors for PDP. For example, BaMgAl₁₀O₁₇:Eu is used as a blue phosphor, and (Y,Gd)Al₃B₄O₁₂:Tb is used as a green phosphor in the form of a mixture with Zn₂SiO₄:Mn.

However, the use of Zn₂SiO₄:Mn or a mixture of Zn₂SiO₄:Mn with (Y,Gd)Al₃B₄O₁₂:Tb as a green phosphor leads to a long persistence time (decay time), which deteriorates the moving image characteristics as a PDP. Hence, for PDP applications, there is a strong demand for a green phosphor having a short persistence time.

In response to this demand, a method (e.g., JP 2006-193712 A) of using Y₃Al₅O₁₂:Ce having a very short persistence time as a green phosphor has been proposed.

However, according to the above-mentioned conventional method, the luminance of the green phosphor decreases, though its persistence time can be reduced. Further, it is required to improve the color purity because the color purity of Y₃Al₅O₁₂:Ce is poor, compared to that of Zn₂SiO₄:Mn or (Y,Gd)Al₃B₄O₁₂:Tb.

### SUMMARY OF THE INVENTION

The present disclosure has been made to solve the above-mentioned conventional problems, and one non-limiting and exemplary embodiment provides a highly efficient PDP and a highly efficient green phosphor layer, each having high luminance and color purity as well as a short persistence time.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

In one general aspect, the techniques disclosed here feature a plasma display panel (PDP) including: a front panel; a back panel that is arranged to face the front panel; barrier ribs that define a clearance between the front panel and the back panel; a pair of electrodes that are disposed on the back panel or the front panel; an external circuit that is connected to the electrodes; a discharge gas that is present at least between the electrodes and contains xenon that generates a vacuum ultraviolet ray by applying a voltage between the electrodes through the external circuit; and a green phosphor layer that emits visible light induced by the vacuum ultraviolet ray. In this PDP, the green phosphor layer includes a phosphor represented by a general formula: aYO_{3/2}.(3−a)CeO_{3/2}.bAlO_{3/2}.cGaO_{3/2}, where 2.80≦a≦2.99, 1.00≦b≦5.00, 0≦c≦4.00, and 4.00≦b+c≦5.00 are satisfied. In this phosphor, a peak whose peak top is located in a range of diffraction angle 2θ of not less than 16.7 degrees but not more than 16.9 degrees is present in an X-ray diffraction pattern obtained by measurement on the phosphor using an X-ray with a wavelength of 0.774 Å. The green phosphor layer also includes a phosphor represented by a general formula: dZnO.(2−d)MnO.eSiO₂, where 1.80≦d≦1.90 and 1.00≦e≦1.02 are satisfied, in an amount of 30 wt % or more and 80 wt % or less of a total weight of green phosphors.

In another general aspect, the techniques disclosed here feature a green phosphor layer including a phosphor represented by a general formula: aYO_{3/2}.(3−a)CeO_{3/2}.bAlO_{3/2}.cGaO_{3/2}, where 2.80≦a≦2.99, 1.00≦b≦5.00, 0≦c≦4.00, and 4.00≦b+c≦5.00 are satisfied. In this phosphor, a peak whose peak top is located in a range of diffraction angle 2θ of not less than 16.7 degrees but not more than 16.9 degrees is present in an X-ray diffraction pattern obtained by measurement on the phosphor using an X-ray with a wavelength of 0.774 Å. The green phosphor layer also includes a phosphor represented by a general formula: dZnO.(2−d)MnO.eSiO₂, where 1.80≦d≦1.90 and 1.00≦e≦1.02 are satisfied, in an amount of 30 wt % or more and 80 wt % or less of a total weight of green phosphors.

The present disclosure can provide a highly efficient PDP and a highly efficient green phosphor layer, each having high luminance and color purity as well as a short persistence time.

### BRIEF DESCRIPTION OF THE DRAWINGS

FIG. 1 is a schematic cross-sectional view showing a structure of a PDP of the present disclosure.

FIG. 2 shows a powder X-ray diffraction pattern of the phosphor sample No. 1 for Comparative Example in the range of diffraction angle 2θ=16.3 to 16.9 degrees (vertical axis; diffraction intensity; and horizontal axis; diffraction angle 2θ (degrees)).

FIG. 3 shows a powder X-ray diffraction pattern of the phosphor sample No. 11 for Example in the range of diffraction angle 2θ=16.3 to 16.9 degrees (vertical axis; diffraction intensity; and horizontal axis; diffraction angle 2θ (degrees)).

### DETAILED DESCRIPTION

Hereinafter, embodiments of the present disclosure will be described in detail.

<First Phosphor>

The first phosphor used in the present disclosure is represented by the general formula; aYO_{3/2}.(3−a)CeO_{3/2}.bAlO_{3/2}.cGaO_{3/2}, where 2.80≦a≦2.99, 1.00≦b≦5.00, 0≦c≦4.00, and 4.00≦b+c≦5.00 are satisfied. With regard to the coefficient a, a desirable range is 2.97≦a≦2.99 in view of luminance.

The first phosphor is characterized in that a peak whose peak top is located in the range of diffraction angle 2θ of not less than 16.7 degrees but not more than 16.9 degrees is present in an X-ray diffraction pattern obtained by measurement on the phosphor using an X-ray with a wavelength of 0.774 Å.

The inventor has found from his extensive experimental studies that a phosphor having the above composition and satisfying the above characteristics relating to the X-ray diffraction pattern can be a phosphor with high luminance and color purity. With respect to the conventional Y₃Al₅O₁₂;Ce phosphor, no peak is present in the above range of diffraction angle 2θ. Furthermore, since the conventional Y₃Al₅O₁₂;Ce phosphor emits yellow light with high efficiency when excited by blue light, it has a bright yellow color in powder form under natural light. On the other hand, since the phosphor satisfying the above characteristics relating to the X-ray diffraction pattern and used in the present disclosure emits yellow light with lower efficiency, its color is whitish in powder form under natural light. Therefore, in the phosphor satisfying the above characteristics relating to the X-ray diffraction pattern, the self absorption of green light emitted when excited by vacuum ultraviolet light is suppressed. This presumably leads to high luminance and color purity. In addition, the phosphor used in the present disclosure can be produced under the unique conditions as described later. Therefore, the difference in the X-ray diffraction pattern between the conventional phosphor and the phosphor used in the present disclosure comes from a change in the lattice constant of the phosphor resulting from the difference in the production conditions. Presumably, this change in the lattice constant causes a change in the light emission characteristics of the phosphor, that is, an increase in the luminance and color purity.

In the present disclosure, in order to distinguish a peak from a change in signal intensity due to noise and the like in the X-ray diffraction pattern, among the changes in signal intensity, a change in signal intensity having an intensity of at least one hundredth of a peak present in the vicinity of a diffraction angle 2θ of 16.6 degrees is recognized as a peak. In the present disclosure, the phrase “a peak is present” refers to the case where the sign of the differential value at each angle point constituting the spectrum changes from positive to negative within a predetermined range of diffraction angle, while ignoring noise.

Next, a powder X-ray diffraction measurement on the first phosphor will be described.

For the powder X-ray diffraction measurement, for example, BL19B2 powder X-ray diffraction equipment (Debye-Scherrer optical system using an imaging plate; hereinafter referred to as BL19 diffraction equipment) in the large-scale synchrotron radiation facility, SPring 8, is used. Phosphor powder is packed tightly into a Lindemann glass capillary with an internal diameter of 200 μm. The incident X-ray wavelength is set to approximately 0.774 Åusing a monochromator. While a sample is rotated with a goniometer, the diffraction intensity is recorded on the imaging plate. The measuring time is to be determined, paying attention to keep the imaging plate unsaturated. The measuring time is, for example, 5 minutes. The imaging plate is developed and an X-ray diffraction spectrum thereon is read out.

It should be noted that an error from the zero point when the data is read out from the developed imaging plate is approximately 0.03 degrees in terms of diffraction angle 2θ.

An accurate incident X-ray wavelength is obtained using a CeO₂ powder (SRM No. 674a) of NIST (National Institute of Standards and Technology) whose lattice constant is 5.4111 Å. The data measured on the CeO₂ powder is subjected to Rietveld analysis while varying only the lattice constant (a-axis length). The actual X-ray wavelength λ is calculated based on the difference between the value a′ obtained for the predetermined X-ray wavelength λ′ and the actual value (a=5.4111 Å) from the following formula:

λ=aλ′/a′

For the Rietveld analysis, RIETAN-2000 program (Rev. 2.3.9 or later; hereinafter referred to as RIETAN) is used (see NAKAI Izumi, IZUMI Fujio, “Funmatsu X-sen kaiseki-no-jissai—Rietveld hou nyumon” (Practice of powder X-ray analysis—introduction to Rietveld method), Discussion Group of X-Ray Analysis, the Japan Society for Analytical Chemistry, Asakura Publishing, 2002, and http://homepage.mac.com/fujioizumi/).

It should be noted that X-ray diffraction is a phenomenon that is observed when a crystal lattice, incidence of X-ray, and a geometry of diffraction satisfy the Bragg's condition:

2d sin θ=nλ

Though the spectrum can be observed using a commonly available X-ray diffractometer, the diffraction profile observed has some differences because the observed strength depends on the incident X-ray wavelength.

<Second Phosphor>

In the present disclosure, a phosphor mixture including the first phosphor and a second phosphor is used for the green phosphor layer of a PDP. The second phosphor used in the present disclosure is represented by a general formula: dZnO.(2−d)MnO.eSiO₂, where 1.80≦d≦1.90 and 1.00≦e≦1.02 are satisfied. With regard to the coefficient d, a desirable range is 1.82≦d≦1.88 in view of luminance and persistence time.

As described above, the luminance and color purity of the conventional green phosphor Y₃Al₅O₁₂:Ce is not high enough, though it exhibits short persistence. In the present disclosure, however, the luminance and color purity are increased by the first phosphor satisfying the above characteristics relating to the X-ray diffraction pattern. In addition, in the present disclosure, the above-mentioned phosphor is used as the second phosphor. The second phosphor exhibits high luminance, and its color purity is far superior to that of the first phosphor, though its persistence performance is inferior to that of the first phosphor. Therefore, the combined use of the first and second phosphors allows a further increase in the color purity while maintaining the high luminance, without decreasing the persistence performance significantly.

The content of the second phosphor is 30 wt % or more and 80 wt % or less relative to the total weight (100 wt %) of green phosphors. When the content of the second phosphor is less than 30 wt %, the resulting color purity is insufficient. On the other hand, the content of the second phosphor exceeds 80 wt %, the resulting luminance is insufficient.

<Third Phosphor>

In a desirable embodiment of the present disclosure, a phosphor mixture including the first phosphor, the second phosphor and a third phosphor is used for the green phosphor layer of a PDP. The third phosphor used in the present disclosure is represented by a general formula: fYO_{3/2}.gTbO_{3/2}.(1−f−g)GdO_{3/2}.3AlO_{3/2}hBO_{3/2}, where 0.20≦f≦0.80, 0.10≦g≦0.40, and 3.50≦h≦4.50 are satisfied. With regard to the coefficient g, a desirable range is 0.15≦g≦0.30 in view of luminance.

The third phosphor exhibits high luminance, and its persistence characteristics and color purity are at an intermediate level between the first phosphor and the second phosphor. Therefore, the use of the third phosphor in combination with the first phosphor and the second phosphor also allows a short persistence time as well as high luminance and color purity to be achieved.

Since the third phosphor is superior in both persistence characteristics and color purity, when it is used, it is desirable that the content of the second phosphor be 30 wt % or more and 60 wt % or less and the content of the third phosphor be 5 wt % or more and 30 wt % or less, relative to the total weight (100 wt %) of green phosphors.

<Production Method of Phosphors>

Hereinafter, the method of producing the phosphors used in the present disclosure will be described. The production method of these phosphors is not limited to the method described below.

As a source material, a compound that is converted into an oxide by firing, such as a hydroxide, a carbonate, and a nitrate, each having a high purity (purity of 99% or more), may be used. An oxide having a high purity (purity of 99% or more) also may be used.

It is desirable that a small amount of a fluoride such as aluminum fluoride or a chloride such as zinc chloride be added thereto to accelerate the reaction.

The phosphor is produced by mixing the above source materials and firing the mixed powder. The method of mixing the source materials may be wet mixing in a solution or dry mixing of dry powders. A ball mill, a stirred media mill, a planetary mill, a vibration mill, a jet mill, a V-type mixer, an agitator, and the like, which are in general industrial use, may be used.

The method of firing the mixed powder depends on the composition of each phosphor. The first phosphor is fired first in air at a temperature of 1100 to 1600° C. for about 1 to 50 hours. Further, it is fired in a low oxygen partial pressure atmosphere, such as a nitrogen gas containing 0.1 to 10 vol % of hydrogen, a nitrogen gas, or the like, at a temperature of 1000 to 1400° C. for about 1 to 50 hours. In this way, the mixed powder is fired in two steps under different atmospheres, thereby allowing a phosphor satisfying the above characteristics relating to the X-ray diffraction pattern to be obtained efficiently.

The second phosphor is typically fired in carbon dioxide containing 0 to 50 vol % of nitrogen at a temperature of 1100 to 1300° C. for about 1 to 10 hours.

The third phosphor is typically fired in air at a temperature of 1100 to 1400° C. for about 1 to 10 hours.

As a furnace to be used for the firing, furnaces that are in general industrial use may be used. A gas furnace or an electric furnace of the batch type or continuous type such as a pusher furnace may be used.

The particle size distribution and flowability of the phosphor powder can be adjusted by crushing the obtained phosphor powder again using a ball mill, a jet mill, or the like, and further by washing or classifying it, if necessary.

<Structure of PDP>

The PDP of the present disclosure is characterized in that the green phosphor layer includes the above-mentioned phosphor mixture (this green phosphor layer is also the green phosphor layer of the present disclosure). This allows the PDP to have a short persistence time and high luminance and color purity, and thus be highly efficient. Therefore, the PDP is suitable also for stereoscopic image display. It should be noted that the green phosphor layer may include a green phosphor other than the first phosphor, the second phosphor, and the third phosphor as long as the effects of the present disclosure are not impaired.

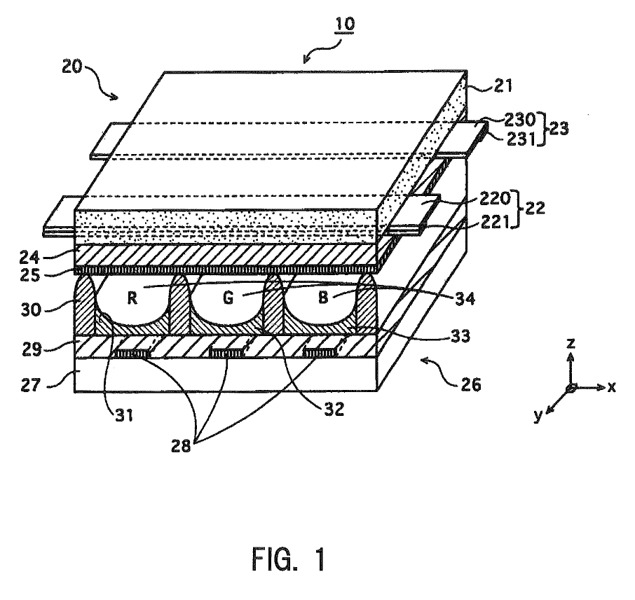

Hereinafter, the PDP of the present disclosure will be described with an example of an AC surface-discharge type PDP. FIG. 1 is a cross-sectional perspective view showing the basic structure of an AC surface-discharge type PDP 10. It should be noted that the PDP shown here is illustrated for convenience with a size that is appropriate for a specification of 1024×768 pixels, which is the 42-inch class, and the present disclosure may be applied to other sizes and specifications as well.

As illustrated in FIG. 1, this PDP 10 includes a front panel 20 and a back panel 26, and these panels are arranged with their main surfaces facing each other.

The front panel 20 includes a front panel glass 21 as a front substrate, strip-shaped display electrodes (X-electrode 23, Y-electrode 22) provided on one main surface of the front panel glass 21, a front-side dielectric layer 24 having a thickness of approximately 30 μm covering the display electrodes, and a protective layer 25 having a thickness of approximately 1.0 μm provided on the front-side dielectric layer 24.

The above display electrode includes a strip-shaped transparent electrode 220 (230) having a thickness of 0.1 μm and a width of 150 μm, and a bus line 221 (231) having a thickness of 7 μm and a width of 95 μm and laid on the transparent electrode. A plurality of pairs of the display electrodes are disposed in the y-axis direction, with their longitudinal direction in the x-axis direction.

The display electrodes (X-electrode 23, Y-electrode 22) of each pair are connected electrically to a panel drive circuit (not shown) respectively in the vicinity of the ends of the width direction (y-axis direction) of the front panel glass 21. It should be noted that the Y-electrodes 22 are connected collectively to the panel drive circuit and the X-electrodes 23 each are connected independently to the panel drive circuit. When the Y-electrodes 22 and a certain X-electrode 23 are fed using the panel drive circuit, a surface discharge (sustained discharge) is generated in the gap (approximately 80 μm) between the X-electrode 23 and the Y-electrode 22. The X-electrode 23 also can operate as a scan electrode, and in this case, a write discharge (address discharge) can be generated between the X-electrode 23 and an address electrode 28 to be described later.

The above-mentioned back panel 26 includes a back panel glass 27 as a back substrate, a plurality of address electrodes 28, a back-side dielectric layer 29, barrier ribs 30, and phosphor layers 31 to 33, each of which corresponds to one color of red (R), green (G), and blue (B). The phosphor layers 31 to 33 are provided so that they contact with the side walls of two adjacent barrier ribs 30 and with the back-side dielectric layer 29 between the adjacent barrier ribs 30, and repeatedly are disposed in sequence in the x-axis direction.

The green phosphor layer (G) includes the above phosphor mixture. On the other hand, the red phosphor layer (R) and the blue phosphor layer (B) include commonly-used phosphors. Examples of the red phosphor include Y(P,V)O₄:Eu, Y₂O₃:Eu and (Y,Gd)BO₃:Eu, and examples of the blue phosphor include BaMgAl₁₀O₁₇:Eu.

Each phosphor layer can be formed by applying a phosphor ink in which phosphor particles are dissolved to the barrier ribs 30 and the back-side dielectric layer 29 by a known applying method such as a meniscus method and a line jet method, and drying and firing the ink (e.g., at 500° C., for 10 minutes). The above-mentioned phosphor ink can be prepared, for example, by mixing 30 wt % of a green phosphor having a volume average particle diameter of 2 μm, 4.5 wt % of ethyl cellulose with a weight average molecular weight of approximately 200,000, and 65.5 wt % of butyl carbitol acetate. In this regard, it is desirable to adjust the viscosity of the ink eventually to approximately 2000 to 6000 cps (2 to 6 Pas) in order to enhance the adherence of the ink to the barrier ribs 30.

The address electrodes 28 are provided on the one main surface of the back panel glass 27. The back-side dielectric layer 29 is provided so as to cover the address electrodes 28. The barrier ribs 30 have a height of approximately 150 μm and a width of approximately 40 μm. The barrier ribs 30 are arranged on the back-side dielectric layer 29, with their longitudinal direction in the y-axis direction, so as to correspond to the pitch of the adjacent address electrodes 28.

Each of the address electrodes 28 has a thickness of 5 μm and a width of 60 μm. A plurality of address electrodes 28 are arranged in the x-axis direction, with their longitudinal direction in the y-axis direction. The address electrodes 28 are disposed at a certain pitch (approximately 150 μm). A plurality of address electrodes 28 each are connected independently to the above-mentioned panel drive circuit. Address discharge can be generated between a certain address electrode 28 and a certain X-electrode 23 by feeding each address electrode individually.

The front panel 20 and the back panel 26 are disposed so that the address electrode 28 and the display electrode are orthogonal to each other. The peripheral portions of both the panels 20 and 26 are bonded and sealed with a frit glass sealing portion (not shown) that serves as a sealing member.

An enclosed space between the front panel 20 and the back panel 26, which has been bonded and sealed with the frit glass sealing portion, is filled with a discharge gas composed of a rare gas such as He, Xe or Ne at a predetermined pressure (ordinarily approximately 6.7×10⁴ to 1.0×10⁵ Pa).

It should be noted that a space corresponding to a space between two adjacent barrier ribs 30 is a discharge space 34. A region where a pair of display electrodes intersect one address electrode 28 with the discharge space 34 disposed therebetween corresponds to a cell used for displaying an image. It should be noted that in this embodiment, the cell pitch in the x-axis direction is set to approximately 300 μm and the cell pitch in the y-axis direction is set to approximately 675 μm.

When the PDP 10 is driven, an address discharge is generated by applying a pulse voltage to a certain address electrode 28 and a certain X-electrode 23 by the panel drive circuit, and after that, a sustained discharge is generated by applying a pulse between a pair of display electrodes (X-electrode 23, Y-electrode 22). The phosphors included in the phosphor layers 31 to 33 are allowed to emit visible light using the ultraviolet ray with a short wavelength (a resonance line with a central wavelength of approximately 147 nm and a molecular beam with a central wavelength of 172 nm) thus generated. Thereby, a prescribed image can be displayed on the front panel side.

### EXAMPLES

Hereinafter, the present disclosure will be described in detail with reference to Examples and Comparative Examples. However, the present disclosure is not limited to these Examples.

<Preparation of First Phosphor Samples>

As starting materials, Y₂O₃, Al₂O₃, Ga₂O₃, and CeO₂ were used. These were weighed to have a particular composition, and wet-mixed in pure water using a ball mill after 1 wt % of AlF₃ was further added thereto. With regard to sample Nos. 1 to 4, the mixture was dried and thereafter was fired in air at 1200 to 1500° C. for 4 hours, thereby allowing a phosphor to be obtained (firing condition A). With regard to sample No. 5, the mixture was dried and thereafter fired in a nitrogen gas containing 0.1 vol % of hydrogen at 1500° C. for 4 hours, thereby allowing a phosphor to be obtained (firing condition B). Meanwhile, with regard to sample Nos. 6 to 13, 15, and 16, the mixture was dried and thereafter fired in air at 1200 to 1500° C. for 4 hours, and it was further fired in a nitrogen gas containing 0.1 vol % of hydrogen at 1000 to 1400° C. for 4 hours, thereby allowing a phosphor to be obtained (firing condition C). With regard to sample No. 14, the mixture was dried and thereafter fired in air at 1200° C. for 4 hours, and it was further fired in a nitrogen gas at 1100° C. for 4 hours, thereby allowing a phosphor to be obtained (firing condition D). Table 1 shows the above-mentioned firing condition and composition ratio of each of the thus prepared phosphors. In Table 1, the samples marked with an asterisk are samples for Comparative Examples, which do not fall under the category of the first phosphors.

The α-Al₂O₃ material (average particle size of 1 μm), which is commonly used, was used as Al₂O₃ material for the samples for Comparative Examples, whereas the θ-Al₂O₃ material (average particle size of 0.1 μm) was used as Al₂O₃ material for the samples for Examples.

<Powder X-Ray Analysis Measurement>

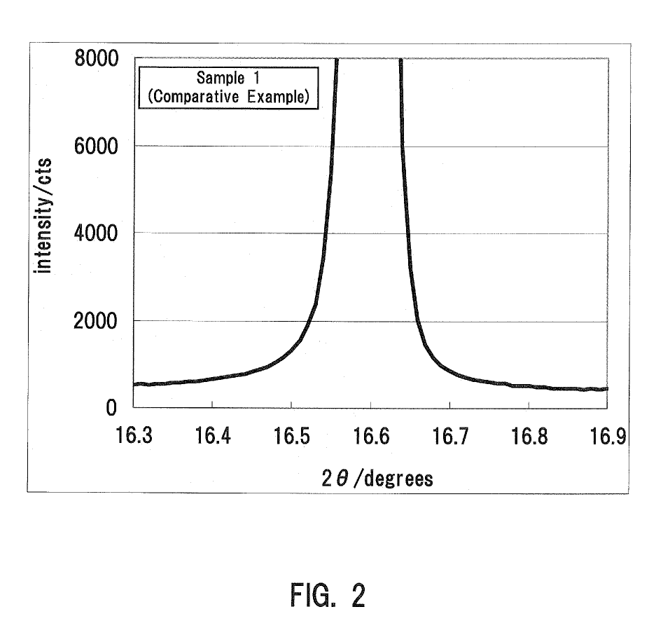

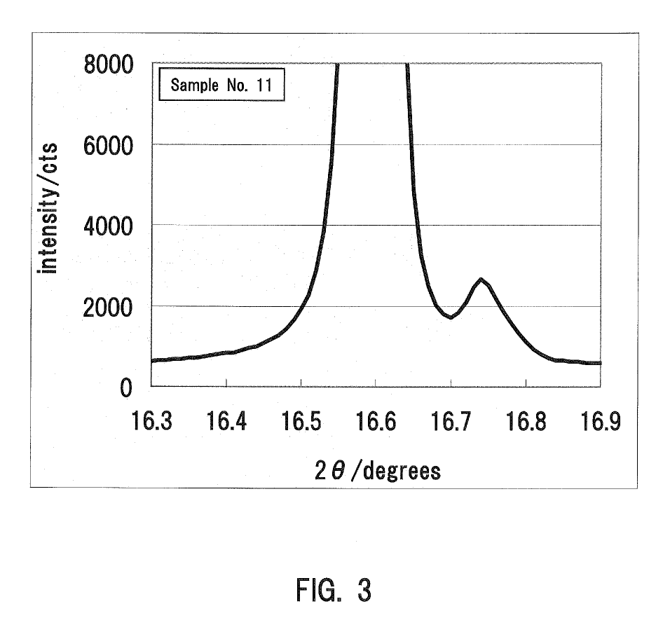

The X-ray diffraction patterns of the phosphor samples for Examples and Comparative Examples were measured by the above-mentioned method, using BL19 diffraction equipment in the large-scale synchrotron radiation facility, SPring 8. Table 1 shows the presence or absence of a peak whose peak top is located in the range of diffraction angle 2θ of not less than 16.7 degrees but not more than 16.9 degrees in the obtained X-ray diffraction pattern and the position of the peak. Further, FIG. 2 and FIG. 3 each show an example of the obtained X-ray diffraction pattern (sample Nos. 1 and 11).

<Measurement of Luminance and Chromaticity>

The measurement of the luminance and chromaticity was carried out by irradiating the phosphor samples for Examples and Comparative Examples with a vacuum ultraviolet ray with a wavelength of 146 nm in vacuum and measuring the luminescence in the visible region. Table 1 shows the measured luminance (Y) and chromaticity (x, y). It should be noted that Y is the luminance Y in the XYZ color coordinate system of International Commission on Illumination, and expressed as a value relative to that of sample No. 1.

TABLE 1

| | | | | Firing | Peak | | | |
|---|---|---|---|---|---|---|---|---|
| Sample | | | | condi- | position | Y | | |
| No. | a | b | c | tion | (degrees) | (%) | x | y |
| *1 | 2.80 | 5.00 | 0 | A | Absent | 100 | 0.433 | 0.544 |
| *2 | 2.70 | 5.20 | 0 | A | Absent | 85 | 0.425 | 0.532 |
| *3 | 2.80 | 0.50 | 5.50 | A | Absent | 52 | 0.403 | 0.485 |
| *4 | 2.80 | 3.50 | 0 | A | Absent | 60 | 0.445 | 0.502 |
| *5 | 2.80 | 5.00 | 0 | B | Absent | 105 | 0.415 | 0.526 |
| 6 | 2.80 | 5.00 | 0 | C | 16.76 | 120 | 0.392 | 0.552 |
| 7 | 2.99 | 5.00 | 0 | C | 16.85 | 128 | 0.389 | 0.550 |
| 8 | 2.97 | 4.00 | 0 | C | 16.80 | 125 | 0.389 | 0.556 |
| 9 | 2.98 | 4.80 | 0 | C | 16.78 | 132 | 0.392 | 0.562 |
| 10 | 2.98 | 1.00 | 4.00 | C | 16.84 | 130 | 0.329 | 0.552 |
| 11 | 2.98 | 3.00 | 1.80 | C | 16.74 | 134 | 0.345 | 0.553 |
| 12 | 2.98 | 4.60 | 0.20 | C | 16.78 | 136 | 0.388 | 0.558 |
| 13 | 2.85 | 4.60 | 0 | C | 16.76 | 118 | 0.390 | 0.560 |
| 14 | 2.98 | 4.80 | 0 | D | 16.76 | 126 | 0.391 | 0.558 |
| 15 | 2.94 | 1.00 | 4.00 | C | 16.90 | 114 | 0.332 | 0.556 |
| 16 | 2.94 | 4.00 | 1.00 | C | 16.70 | 116 | 0.368 | 0.554 |

As is clear from Table 1, the phosphors each having a composition ratio in the composition range of the present disclosure and with a peak present in the range of diffraction angle 2θ of not less than 16.7 degrees but not more than 16.9 degrees exhibit high luminance under vacuum ultraviolet excitation and have improved color purity of green emission (the chromaticity value x is low and the chromaticity value y is high). Among them, the phosphors (sample Nos. 7 to 12 and 14) each having a composition ratio in the range of 2.97≦a≦2.99 exhibit particularly high luminance.

The phosphor samples for Examples were pulse-irradiated with vacuum ultraviolet light with a wavelength of 146 nm in vacuum to measure the time the luminescence intensity in the visible region took to decay to one tenth ( 1/10 persistence time). As a result, all the times were 0.3 milliseconds or less, which indicates their excellent persistence characteristics.

<Preparation of Second Phosphor Samples>

As starting materials, ZnO, MnCO₃, and SiO₂ were used. These were weighed to have a particular composition, and wet-mixed in pure water using a ball mill. After this mixture was dried, it was fired in carbon dioxide containing 0 to 50 vol % of nitrogen at a temperature of 1100 to 1300° C. for 4 hours, thereby allowing a phosphor to be obtained. Table 2 shows the composition ratio of each of the phosphors thus prepared, and the luminance (Y) and 1/10 persistence time of each sample obtained by the above-mentioned measurement methods. It should be noted that Y is a value relative to that of sample No. 1, and in Table 2, the samples marked with an asterisk are samples for Comparative Examples, which do not fall under the category of the second phosphors.

TABLE 2

| Sample | | | Y | Persistence time |
|---|---|---|---|---|
| No. | d | e | (%) | (ms) |
| *17 | 1.70 | 1.00 | 45 | 3.8 |
| *18 | 1.95 | 1.00 | 85 | 16.8 |
| *19 | 1.84 | 0.90 | 52 | 9.8 |
| *20 | 1.84 | 1.10 | 96 | 7.6 |
| 21 | 1.80 | 1.00 | 106 | 3.2 |
| 22 | 1.90 | 1.02 | 118 | 6.8 |
| 23 | 1.84 | 1.00 | 110 | 3.5 |
| 24 | 1.82 | 1.01 | 108 | 3.4 |

As is clear from Table 2, the phosphors each having a composition ratio in the composition range of the present disclosure exhibit high luminance under vacuum ultraviolet excitation and have a relatively short 1/10 persistence time.

It should be noted that the chromaticity values (x, y) of the phosphor samples for Examples were all within the range of (0.230, 0.700) to (0.240, 0.710), which indicates their very high color purity.

<Preparation of Third Phosphor Samples>

As starting materials, Y₂O₃, Tb₂O₃, Gd₂O₃, and Al₂O₃ were used. These were weighed to have a particular composition, and wet-mixed in pure water using a ball mill. After this mixture was dried, the mixture and H₃BO₄ were weighed to have a particular composition, and dry-mixed using a V-type mixer. The obtained mixture was fired in air at a temperature of 1100 to 1400° C. for 1 to 10 hours, and then washed with water and dried, thereby allowing a phosphor to be obtained. Table 3 shows the composition ratio of each of the phosphors thus prepared, and the luminance (Y) of each sample obtained by the above-mentioned measurement method. It should be noted that Y is a value relative to that of sample No. 1, and in Table 3, the samples marked with an asterisk are samples for Comparative Examples, which do not fall under the category of the third phosphors.

TABLE 3

| Sample | | | | Y |
|---|---|---|---|---|
| No. | f | g | h | (%) |
| *25 | 0.10 | 0.05 | 4.00 | 75 |
| *26 | 0.90 | 0.10 | 3.00 | 52 |
| *27 | 0.20 | 0.50 | 5.00 | 63 |
| 28 | 0.20 | 0.40 | 4.50 | 112 |
| 29 | 0.80 | 0.10 | 3.50 | 108 |
| 30 | 0.60 | 0.30 | 4.00 | 113 |
| 31 | 0.60 | 0.20 | 4.20 | 118 |

As is clear from Table 3, the phosphors each having a composition ratio in the composition range of the present disclosure exhibit high luminance under vacuum ultraviolet excitation.

It should be noted that the chromaticity values (x, y) and the 1/10 persistence times of the phosphor samples for Examples were all about (0.330, 0.580) and about 4.5 milliseconds, respectively.

<Luminance and Chromaticity of Panel Using First Phosphor>

PDPs having the structure of FIG. 1 were fabricated according to the above-described embodiment of an AC surface-discharge type PDP, using the green phosphors obtained in the same manner as in the phosphors of sample Nos. 1 and 7 to 9. The initial luminance (value relative to that in the case of using sample No. 1) and chromaticity of each of the PDPs thus fabricated were measured. Table 4 shows the results. Each panel displayed a fixed image with one color of green. In Table 4, the sample marked with an asterisk uses a phosphor sample for Comparative Example.

TABLE 4

| | | | | | Peak | | | |
|---|---|---|---|---|---|---|---|---|
| Sam- | | | | Firing | position | Panel characteristics | | |
| ple | | | | condi- | (de- | Luminance | | |
| No. | a | b | c | tion | grees) | (%) | x | y |
| *32 | 2.80 | 5.00 | 0 | A | Absent | 100 | 0.442 | 0.540 |
| 33 | 2.99 | 5.00 | 0 | C | 16.85 | 132 | 0.382 | 0.556 |
| 34 | 2.97 | 4.00 | 0 | C | 16.80 | 129 | 0.385 | 0.560 |
| 35 | 2.98 | 4.80 | 0 | C | 16.78 | 135 | 0.390 | 0.568 |

As is clear from Table 4, it was confirmed that the panels using the first phosphors exhibited high luminance and improved color purity. The 1/10 persistence times of the panels using the first phosphors were measured. As a result, all the times were 0.2 milliseconds or less, which were very short.

<Luminance, Chromaticity and Persistence Time of Panel Using First and Second Phosphors>

PDPs having the structure of FIG. 1 were fabricated according to the above-described embodiment of an AC surface-discharge type PDP, using the green phosphors obtained in the same manner as in the phosphors of sample Nos. 1, 9, and 21 to 23 in the form of mixtures thereof. The initial luminance (value relative to that in the case of using only sample No. 1), chromaticity, and 1/10 persistence time of each of the PDPs thus fabricated were measured. Table 5 shows the results. Each panel displayed a fixed image with one color of green. In Table 5, the samples marked with an asterisk are Comparative Examples.

TABLE 5

| | | | Panel characteristics | | | |
|---|---|---|---|---|---|---|
| Sam- | | | Lumi- | | | Persistence |
| ple | Sample No. and weight | | nance | | | time |
| No. | % of phosphor used | | (%) | x | y | (ms) |
| *36 | Sample No. 1 | 70 wt % | 99 | 0.378 | 0.588 | 4.5 |
| | Sample No. 22 | 30 wt % | | | | |
| 37 | Sample No. 9 | 70 wt % | 124 | 0.355 | 0.600 | 3.8 |
| | Sample No. 22 | 30 wt % | | | | |
| 38 | Sample No. 9 | 70 wt % | 122 | 0.358 | 0.593 | 2.4 |
| | Sample No. 21 | 30 wt % | | | | |
| 39 | Sample No. 9 | 70 wt % | 123 | 0.356 | 0.594 | 2.5 |
| | Sample No. 23 | 30 wt % | | | | |
| 40 | Sample No. 9 | 50 wt % | 117 | 0.328 | 0.620 | 2.8 |
| | Sample No. 23 | 50 wt % | | | | |
| 41 | Sample No. 9 | 30 wt % | 110 | 0.296 | 0.650 | 3.0 |
| | Sample No. 21 | 70 wt % | | | | |
| 42 | Sample No. 9 | 20 wt % | 105 | 0.277 | 0.667 | 3.4 |
| | Sample No. 21 | 80 wt % | | | | |
| *43 | Sample No. 1 | 20 wt % | 88 | 0.279 | 0.669 | 3.5 |
| | Sample No. 21 | 80 wt % | | | | |
| *44 | Sample No. 21 | 100 wt % | 82 | 0.240 | 0.700 | 3.6 |

As is clear from Table 5, it was confirmed that the panels each using the first phosphor and the second phosphor in the form of a mixture had improved color purity without a significant decrease in the panel luminance and persistence characteristics.

In addition, it was confirmed that the color purity tends to decrease as the content of the second phosphor decreases, and the panel luminance tends to decrease as the content thereof increases. This shows that the content of the second phosphor is desirably 30 wt % or more in view of color purity and desirably 80 wt % or less in view of panel luminance, relative to the total weight of green phosphors (the total of the first phosphor and the second phosphors).

<Luminance, Chromaticity, and Persistence Time of Panel Using First to Third Phosphors>

PDPs having the structure of FIG. 1 were fabricated according to the above-described embodiment of an AC surface-discharge type PDP, using the green phosphors obtained in the same manner as in the phosphors of samples Nos. 1, 9, 23 and 31 in the form of mixtures thereof. The initial luminance (value relative to that in the case of using only sample No. 1), chromaticity, and 1/10 persistence time of each of the PDPs thus fabricated were measured. Table 6 shows the results. Each panel displayed a fixed image with one color of green. In Table 6, the sample marked with an asterisk is Comparative Example.

TABLE 6

| | | | Panel characteristics | | | |
|---|---|---|---|---|---|---|
| | | | Lumi- | | | Persistence |
| Sample | Sample No. and weight | | nance | | | time |
| No. | % of phosphor used | | (%) | x | y | (ms) |
| *45 | Sample No. 1 | 65 wt % | 95 | 0.372 | 0.590 | 4.2 |
| | Sample No. 23 | 30 wt % | | | | |
| | Sample No. 31 | 5 wt % | | | | |
| 46 | Sample No. 9 | 65 wt % | 122 | 0.353 | 0.596 | 3.0 |
| | Sample No. 23 | 30 wt % | | | | |
| | Sample No. 31 | 5 wt % | | | | |
| 47 | Sample No. 9 | 30 wt % | 111 | 0.305 | 0.638 | 3.5 |
| | Sample No. 23 | 60 wt % | | | | |
| | Sample No. 31 | 10 wt % | | | | |
| 48 | Sample No. 9 | 40 wt % | 118 | 0.336 | 0.602 | 3.2 |
| | Sample No. 23 | 30 wt % | | | | |
| | Sample No. 31 | 30 wt % | | | | |
| 49 | Sample No. 9 | 40 wt % | 116 | 0.321 | 0.622 | 2.9 |
| | Sample No. 23 | 50 wt % | | | | |
| | Sample No. 31 | 10 wt % | | | | |
| 50 | Sample No. 9 | 60 wt % | 124 | 0.350 | 0.597 | 2.6 |
| | Sample No. 23 | 30 wt % | | | | |
| | Sample No. 31 | 10 wt % | | | | |

As is clear from Table 6, it was confirmed that the panels each using the first to third phosphors in the form of a mixture had improved color purity without a significant decrease in the panel luminance and persistence characteristics.

### INDUSTRIAL APPLICABILITY

The present disclosure can provide a highly efficient plasma display panel and a highly efficient green phosphor layer, each having high luminance and color purity as well as a short persistence time. This plasma display panel is also suitable for stereoscopic image display.

What is claimed is:

1. A plasma display panel comprising:
a front panel;
a back panel that is arranged to face the front panel;
barrier ribs that define a clearance between the front panel and the back panel;
a pair of electrodes that are disposed on the back panel or the front panel;
an external circuit that is connected to the electrodes;
a discharge gas that is present at least between the electrodes and contains xenon that generates a vacuum ultraviolet ray by applying a voltage between the electrodes through the external circuit; and
a green phosphor layer that emits visible light induced by the vacuum ultraviolet ray,
wherein the green phosphor layer includes:
a phosphor represented by a general formula: aYO_{3/2}.(3−a)CeO_{3/2}.bAlO_{3/2}.cGaO_{3/2}, where 2.80≦a≦2.99, 1.00≦b≦5.00, 0≦c≦4.00, and 4.00≦b+c≦5.00 are satisfied, wherein a peak whose peak top is located in a range of diffraction angle 2θ of not less than 16.7 degrees but not more than 16.9 degrees is present in an X-ray diffraction pattern obtained by measurement on the phosphor using an X-ray with a wavelength of 0.774 Å; and
a phosphor represented by a general formula: dZnO.(2−d)MnO.eSiO₂, where 1.80≦d≦1.90 and 1.00≦e≦1.02 are satisfied, in an amount of 30 wt % or more and 80 wt % or less of a total weight of green phosphors.

2. The plasma display panel according to claim 1, wherein
the green phosphor layer includes the phosphor represented by the general formula: dZnO.(2−d)MnO.eSiO₂, where 1.80≦d≦1.90 and 1.00≦e≦1.02 are satisfied, in an amount of 30 wt % or more and 60 wt % or less of the total weight of green phosphors, and
the green phosphor layer further includes a phosphor represented by a general formula: fYO_{3/2}.gTbO_{3/2}.(1−f−g)GdO_{3/2}.3AlO_{3/2}.hBO_{3/2}, where 0.20≦f≦0.80, 0.10≦g≦0.40, and 3.50≦h≦4.50 are satisfied, in an amount of 5 wt % or more and 30 wt % or less of the total weight of green phosphors.

3. A green phosphor layer comprising:
a phosphor represented by a general formula: aYO_{3/2}.(3−a)CeO_{3/2}.bAlO_{3/2}.cGaO_{3/2}, where 2.80≦a≦2.99, 1.00≦b≦5.00, 0≦c≦4.00, and 4.00≦b+c≦5.00 are satisfied, wherein a peak whose peak top is located in a range of diffraction angle 2θ of not less than 16.7 degrees but not more than 16.9 degrees is present in an X-ray diffraction pattern obtained by measurement on the phosphor using an X-ray with a wavelength of 0.774 Å; and
a phosphor represented by a general formula: dZnO.(2−d)MnO.eSiO₂, where 1.80≦d≦1.90 and 1.00≦e≦1.02 are satisfied, in an amount of 30 wt % or more and 80 wt % or less of a total weight of green phosphors.

4. The green phosphor layer according to claim 3, comprising:
the phosphor represented by the general formula: dZnO.(2−d)MnO.eSiO₂, where 1.80≦d≦1.90 and 1.00≦e≦1.02 are satisfied, in an amount of 30 wt % or more and 60 wt % or less of the total weight of green phosphors; and
further a phosphor represented by a general formula: fYO_{3/2}.gTbO_{3/2}.(1−f−g)GdO_{3/2}.3AlO_{3/2}hBO_{3/2}, where 0.20≦f≦0.80, 0.10≦g≦0.40, and 3.50≦h≦4.50 are satisfied, in an amount of 5 wt % or more and 30 wt % or less of the total weight of green phosphors.
